(19) United States
(12) Patent Application Publication
(10) Pub. No.: US 2025/0278160 A1
(43) Pub. Date: Sep. 4, 2025

(54) PROVIDING SHORTCUTS FOR USER INTERFACE INTERACTIVE ELEMENTS

(71) Applicant: INTERNATIONAL BUSINESS MACHINES CORPORATION, ARMONK, NY (US)

(72) Inventors: Matthew Paul Chapman, Eastleigh (GB); Vlad Balanescu, Southampton (GB); Zoe Gathercole, Southampton (GB); GEORGE HOWARD, Ashford (GB)

(21) Appl. No.: 18/638,810

(22) Filed: Apr. 18, 2024

(30) Foreign Application Priority Data
Feb. 29, 2024 (GB) 2402950.6

(51) Int. Cl. G06F 3/0481; G06F 3/04892; G06F 9/451

(52) U.S. Cl. CPC G06F 3/0481; G06F 9/451; G06F 3/04892

(57) ABSTRACT

Computer technology for providing shortcuts for user interface interactive elements. The method analyzes user interaction frequency with interactive elements of a user interface display and determines a number of most frequently used interactive elements in the display. The method assigns defined shortcut user inputs for the number of most frequently used interactive elements by mapping a shortcut to the interactive element in the display to interact with the interactive element when the shortcut is entered and displays the defined shortcut user inputs for the interactive elements in the display.

### BACKGROUND

The present invention relates to interactive elements in user interfaces (UI), and more specifically, to providing shortcuts for UI interactive elements.

In some user interfaces where input is required, access to interactive elements such as input fields or controls is in a prescribed order accessible via a keyboard. Navigating a user interface via a keyboard can be slow and tedious. When using a keyboard, a user must often tab numerous times to traverse around every interactive element to get to the one the user needs. It can be difficult to navigate when traversal is only in one direction, going forward and backward. For example, if a webpage has thirty clickable buttons displayed vertically, and a user would like to use the keyboard to trigger the action on the third one from the top, it would take numerous tabs or other reserved keys for the user to be able to reach that button.

When navigating a user interface using a mouse or trackpad, it may be possible to jump to an interactive element that is required; however, such navigation may require accuracy when interactive elements are numerous and closely spaced.

As of 9 Apr. 2024, the Wikipedia definition of “shortcut computing) states in part as follows: “In computing, a file shortcut is a handle in a user interface that allows the user to find a file or resource located in a different directory or folder from the place where the shortcut is located. Similarly, an Internet shortcut allows the user to open a page, file or resource located at a remote Internet location or Website.

Shortcuts are typically implemented as a small file containing a target URI or GUID to an object, or the name of a target program file that the shortcut represents. The shortcut might additionally specify parameters to be passed to the target program when it is run. Each shortcut can have its own icon. Shortcuts are very commonly placed on a desktop, in an application launcher panel such as the Microsoft Windows Start menu, or in the main menu of a desktop environment. The functional equivalent in the Macintosh operating system is called an alias. Unix-like systems have symbolic links which point to a target file, and often support desktop files which provide additional configuration details.”

### SUMMARY

According to an aspect of the present invention, there is a method, computer program product and/or system that performs the following operations (not necessarily in the following order): (i) analyzing user interaction frequency with interactive elements of a user interface display; (ii) determining a number of most frequently used interactive elements in the display; (iii) assigning defined shortcut user inputs for the number of most frequently used interactive elements by mapping a shortcut to the interactive element in the display to interact with the interactive element when the shortcut is entered; and (iv) displaying the defined shortcut user inputs for the interactive elements in the display.

According to an aspect of the present invention there is provided a computer-implemented method for providing shortcuts for user interface interactive elements, said method comprising: analyzing user interaction frequency with interactive elements of a user interface display; determining a number of most frequently used interactive elements in the display; assigning defined shortcut user inputs for the number of most frequently used interactive elements by mapping a shortcut to the interactive element in the display to interact with the interactive element when the shortcut is entered; and displaying the defined shortcut user inputs for the interactive elements in the display.

According to an aspect of the present invention there is provided a computer program product for providing shortcuts for user interface interactive elements, the computer program product comprising a computer readable storage medium having program instructions embodied therewith, the program instructions executable by a processor to cause the processor to: analyze user interaction frequency with interactive elements of a user interface display; determine a number of most frequently used interactive elements in the display; assign defined shortcut user inputs for the number of most frequently used interactive elements by mapping a shortcut to the interactive element in the display to interact with the interactive element when the shortcut is entered; and display the defined shortcut user inputs for the interactive elements in the display.

The computer readable storage medium may be a non-transitory computer readable storage medium, and the computer readable program code may be executable by a processing circuit.

### BRIEF DESCRIPTION OF THE DRAWINGS

FIG. 1 is a flow diagram of an example embodiment of a method in accordance with embodiments of the present invention;

FIG. 2 is a flow diagram of an example of the method of FIG. 1;

FIG. 3 is a flow diagram of an aspect of the method of FIG. 1;

FIG. 4 is a schematic diagram illustrating an example graphical user interface in accordance with the present invention;

FIG. 5 is a block diagram of an example embodiment of a system in accordance with embodiments of the present invention; and

FIG. 6 is a block diagram of an example embodiment of a computing environment for the execution of at least some of the computer code involved in performing the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

The methods described herein may have the advantage of reducing a time for interaction of a user with a user interface by making shortcuts available for the most popular actions carried out in relation to interactive elements of the user interface. The shortcuts may be updated and may be based on the actions of multiple users or a single user. This is particularly beneficial where navigation where the user uses a keyboard to navigate user interface screen(s).

Embodiments of a method, system, and computer program product are described for providing shortcuts for user interface interactive elements in a user interface display.

User interfaces may take various forms as the space where interactions between humans and machines occur. User interfaces include a display of information and multiple interactive elements facilitating a specific user-computer interaction. User interfaces may include Graphical User Interfaces (GUI) including graphical interactive elements such as icons, buttons, menus, etc.

User interface displays may be provided for a wide range of products including operating systems, browsers, webpages, applications, product user interfaces, windows, documents, spreadsheets, forms, etc. The user interfaces may be shared by multiple users in web-based user interfaces, may be private to an individual user on a private machine, or may be accessible to a specific group of users such as in a corporation.

The interactive elements may be input controls for selecting options or entering information. The interactive elements may be navigation components that facilitate navigation within a display or to move to another display. The user interface may be a graphical user interface. The user input to the user interface may be via an input device such as a keyboard, mouse, trackpad, touchscreen, etc.

The interactive elements appear as a visible part of the user interface as defined by the theme and rendered by the rendering engine. User interface libraries contain a collection of controls and the logic to render these.

The provision of shortcuts for interactive elements in a user interface is an improvement in the technical field of computer human interfaces and more particularly in the technical field of increased navigational speed of user interfaces.

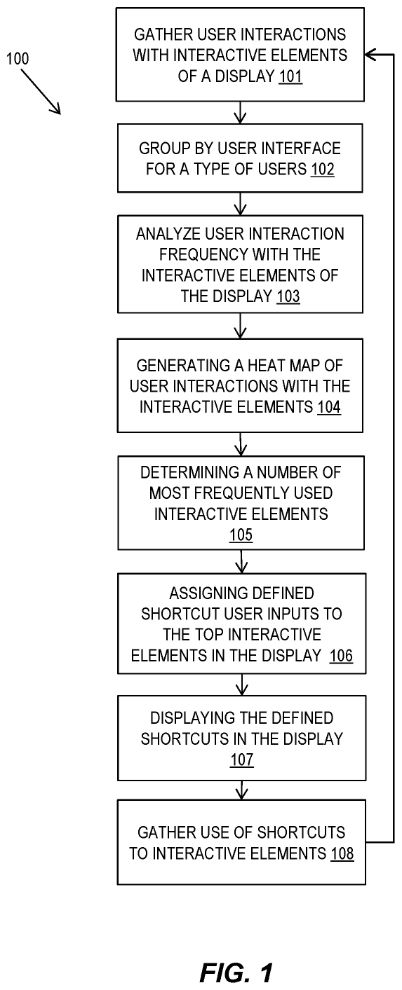

Referring to FIG. 1, a flow diagram 100 shows an example embodiment of the described method for providing shortcuts for interactive elements in a user interface.

The method may gather 101 user interactions with interactive elements of a display of a user interface. The user interactions may include inputs by input devices into the user interface display. The input devices may include a keyboard with multiple keys, a pointer device, a touchscreen, etc. The inputs may be option selections, input of text or numerals, navigation inputs, etc. Gathering user interactions may include gathering data relating to input counts, input locations, navigation patterns, etc.

In the case of a user interface display of a local application on a user's device, gathering user interactions may gather a single user's interactions locally at their machine. In the case of a user interface display that is shared by multiple users, for example, via a web application or web page, gathering user interactions may gather the user interactions of users of the shared user interface.

Gathering user interaction data may use activity tracking or analytics for web pages or applications, click tracking, scroll tracking and other known functionality for a user interface. These functionalities add tracking code to a display of a user interface, for example, for a web site or an application. For example, using web application analytics, a collection of data will be obtained containing statistical information on user activity on a user interface webpage.

In such cases, the multiple users' interactions may be grouped 102 for a version of a user interface display provided for a type of user to analyze interaction frequency for that group of users. For example, the version may be a language version of a user interface display or a version available in a geographic location. For example, geographical groups of users (i.e. group A located in Thailand which might use a certain webpage in some way and group B of users from America which might use the same page in a totally different way) the analytics will be siloed to that respective group of users.

The method analyzes 103 user interaction frequency with interactive elements of the user interface display. In the case of a user interface display of a local application on a user's device, analyzing user interaction frequency may analyze a single user's interactions in the display using user-specific analytics. In the case of a user interface display of a user interface used by multiple users such as a web page or web application, analyzing user interaction frequency includes analyzing multiple users' interactions in the display using web application analytics.

The method may include generating 104 a heatmap of user interactions with interactive elements in the display. A heatmap is a graphical representation of data with values represented by colors. The heatmap of user interaction frequency may show colors representing the frequency of user interactions with areas of the display at which the interactive elements are provided. The heatmap may also show navigation movement in the display.

The method may determine 105 a number of most frequently used interactive elements in a display. This may be determined from the heatmap by isolating areas of most intense usage colors. The number may be a set number for which shortcuts are to be provided.

The method may assign 106 defined shortcut user inputs for the number of most frequently used interactive elements. The shortcuts may be keyboard shortcuts using specified key combinations that are mapped to the interactive element in the display to move the input device pointer to the interactive element when the key combinations are entered.

The method may assign the key combination to the respective interactive element, for example, an input field/button, etc. and when that certain key combination is entered, the interactive element will be activated. For example, for a submit button, this gets clicked using the keyboard in the same way it would be clicked in a GUI using the pointer and mouse combination.

The method may display 107 the defined shortcut user inputs for the interactive elements in the display as an index. For example, this may display a modal dialog when a user next accesses the display in order to interrupt the user to demand an action. The modal dialog moves the system into a special mode requiring user interaction. In another example, this may display a non-modal dialog that can be available to be acted upon if the user chooses to.

The method may gather 108 data on the use of the shortcuts to interactive elements and this may be added to the analysis 103 for updating the shortcuts.

The method may loop to repeat and update the assigning and displaying based on updated analysis of user interaction with the display. The updating may also take into account the use of the existing shortcuts by users. This allows the shortcuts to be continually updated to the most frequently used interactive elements.

The described method provides improved usability of a user interface with a user spending less time traversing and navigating the user interface. Users can navigate to frequently used areas of a user interface with a shortcut key input.

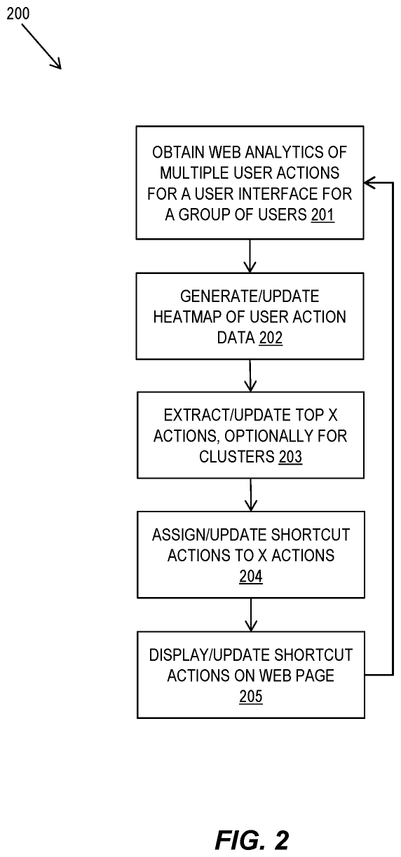

Referring to FIG. 2, a flow diagram 200 shows an example embodiment of the described method in the context of a user interface display in the form of a web-based user interface accessed by multiple users.

The method may obtain 201 web analytics of multiple users of the web-based user interface. Web analytics may be used to collect crowd-sourced data from existing users of the web-based user interface. The crowd-sourced data may contain statistical information on the user interaction with interactive elements. The web analytics may include data such as: click count, location of clicks, scrolling patterns, etc.

The method may obtain the analytics for a group or clusters of users that user a web-based user interface for their common feature such as their geography, language, role, etc. For example, a commerce website might be used in a certain way by the users in a first country compared to the same commerce website used by the users in a second country.

The method may generate 202 a heatmap based on the previously collected data. This may be all the collected data for all users of the user interface or restricted to a group of users. The heatmap displays the mostly intensely used areas that are colored accordingly and that correlate to interactive elements in the display. This can aid in identifying the most used interactive elements by their position in the user interface display.

The method may extract 203 the top x actions in the form of user interactions with the interactive elements in the user interface. The number x is a threshold which may be set to any suitable number depending on how extensive the shortcuts list is desired to be. The top x actions are listed with the most frequent action at the top of the list.

The method may assign 204 a combination of keyboard keys for each action from the top to the bottom of the list of x actions.

The method may display 205 an index between the list of actions and the shortcuts. This may be displayed when it has been generated on the web user interface for future users. In one example, the display of the index may be a modal dialog that interrupts the users' interaction with the content. Alternatively, it may be a non-modal dialog that allows the users to choose whether or not to use the shortcut keys.

The method may repeat and update by refreshing the obtained 201 web analytics and updating 202 the heatmap. The method may update 203 the top x actions by refining and reordering the list of mostly used actions. The method may update 204 the assigned shortcuts and update the display 205. These updates may be carried out continually at set intervals for the web user interface.

The method may use web analytics such as existing user session recording technology to track users' actions over a period of time. Data coverage in the form of heatmaps may be used to build up analytics to calculate the top most used actions and then implement key combination shortcuts to assign to each action. In this way, the usability of a user interface can be greatly improved thereby reducing the amount of time spent by each user trying to use a webpage via keyboard shortcuts.

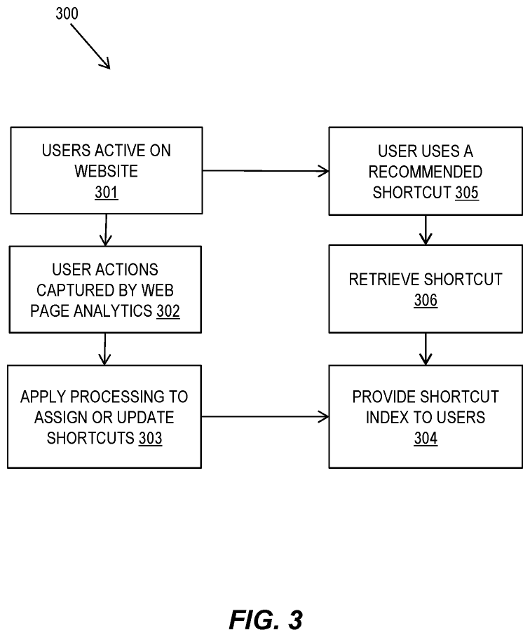

Referring to FIG. 3, a flow diagram 300 illustrates user interaction with a user interface for a website. The users may be active 301 on the website and the user actions may be captured 302 by the webpage analytics. The described processing may be applied 303 to assign or update action shortcuts. The shortcut index may be provided 304 to the users.

As the users are active 301 on the website, the users may use 305 recommended shortcuts in the user interface. The use may retrieve 306 a shortcut and access the interactive element. This use may be updated in the analytics and this may be updated in the provided 304 shortcut index.

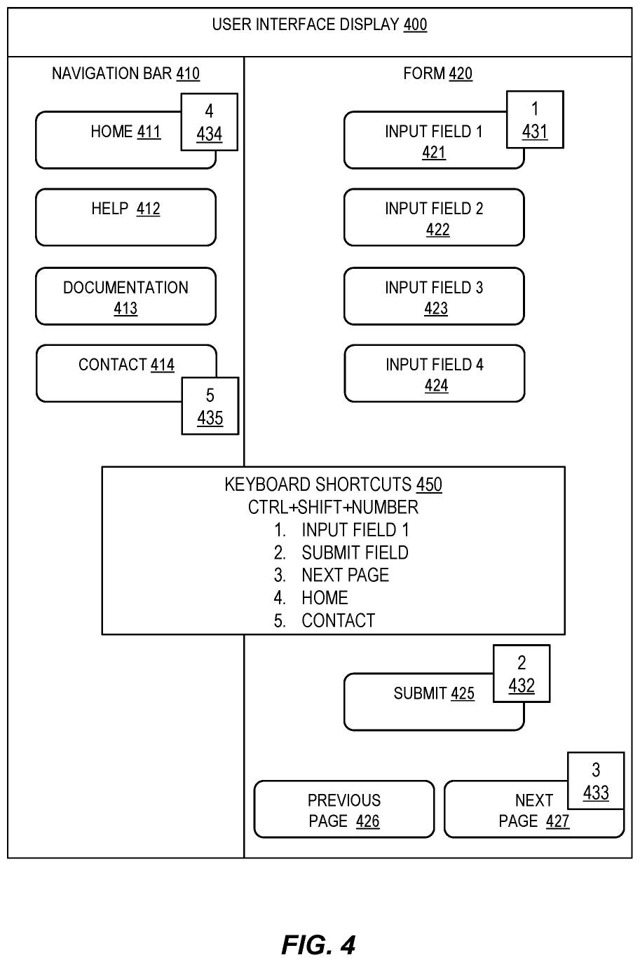

Referring to FIG. 4, a schematic diagram shows an example user interface display 400 in which the described method is applied. The example user interface displays 400 includes a navigation bar 410 portion and a form 420 portion. The example user interface displays 400 includes multiple interactive elements, including interactive elements 411-414 in the navigation bar 410 and interactive elements 421-427 in the form 420. For example, in the navigation bar 410 the interactive elements 411-414 may be input controls to navigate to other pages such as home 411, help 412, documentation 413, contact 414. In the form 420 the interactive elements 421-427 may include a plurality of input fields 421-424, a submit button 425, and previous page 426 and next page 427 navigation buttons.

The order of the most frequently used interactive elements is shows with the first input field element 421 as the most frequently used 431, the submit element 425 as the second most frequently used 432, the next page element 427 as the third most frequently used 433, the home element 411 as the fourth most frequently used 434, and the contact element 414 as the fifth most frequently used 435.

An example dialog of the keyboard shortcuts 450 is displayed. In this example, the shortcuts are the combinations of the control and shift keys with one of the indexed number keys. In this case the number key 1 for the first input field element 421, number key 2 for the submit element 425, number key 3 for the next page element 427, number key 4 for the home element 411, and number key 5 for the contact element 414.

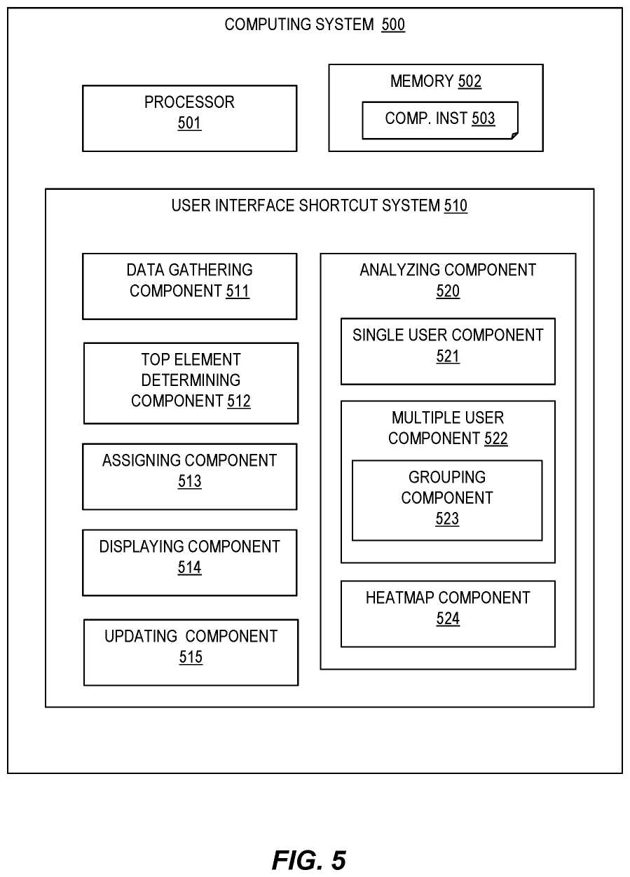

FIG. 5 shows a block diagram of a computing system 500 in which the described method and system may be implemented. The computing system 500 may include at least one processor 501, a hardware module, or a circuit for executing the functions of the described components which may be software units executing on the at least one processor. Multiple processors running parallel processing threads may be provided enabling parallel processing of some or all of the functions of the components. Memory 502 may be configured to provide computer instructions 503 to the at least one processor 501 to carry out the functionality of the components.

A user interface shortcut system 510 may be provided and implemented on the computing system 500. The user interface shortcut system 510 may include a data gathering component 511 for gathering user interactions with interactive elements of the display including input device inputs and navigation of the display. The data gathering component 511 may gather analytics from user interface analytic providing systems.

The user interface shortcut system 510 includes an analyzing component 512 for analyzing user interaction frequency with interactive elements of a graphical user interface display. The analyzing component 520 may include a single user component 521 analyzing a single user's interactions in the display using user specific analytics. The analyzing component 520 may include a multiple user component 522 for analyzing multiple users' interactions in the display using web application analytics. The multiple user component 522 may include a grouping component 523 for grouping the multiple users' interactions based on a type or common feature of users and displaying the defined shortcut user inputs displays the shortcut user inputs for the group of users.

The analyzing component 520 may include a heatmap component 524 for generating a heatmap of user interactions with interactive elements in the display.

The user interface shortcut system 510 may include a top element determining component 512 for determining a number of most frequently used interactive elements in the display.

The user interface shortcut system 510 may include an assigning component 513 for assigning defined shortcut user inputs for the number of most frequently used interactive elements by mapping a shortcut to the interactive element in the display to interact with the interactive element when the shortcut is entered.

The user interface shortcut system 510 may include a displaying component 514 for displaying the defined shortcut user inputs for the interactive elements in the display. The displaying component 514 may display a modal dialog when a user next accesses the display.

The user interface shortcut system 510 may include an updating component 515 for repeating the method and updating the assigning and displaying based on updated analysis. The data gathering component 511 may include gathering data on the user of the shortcuts to interactive elements for use by the updating component 515.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

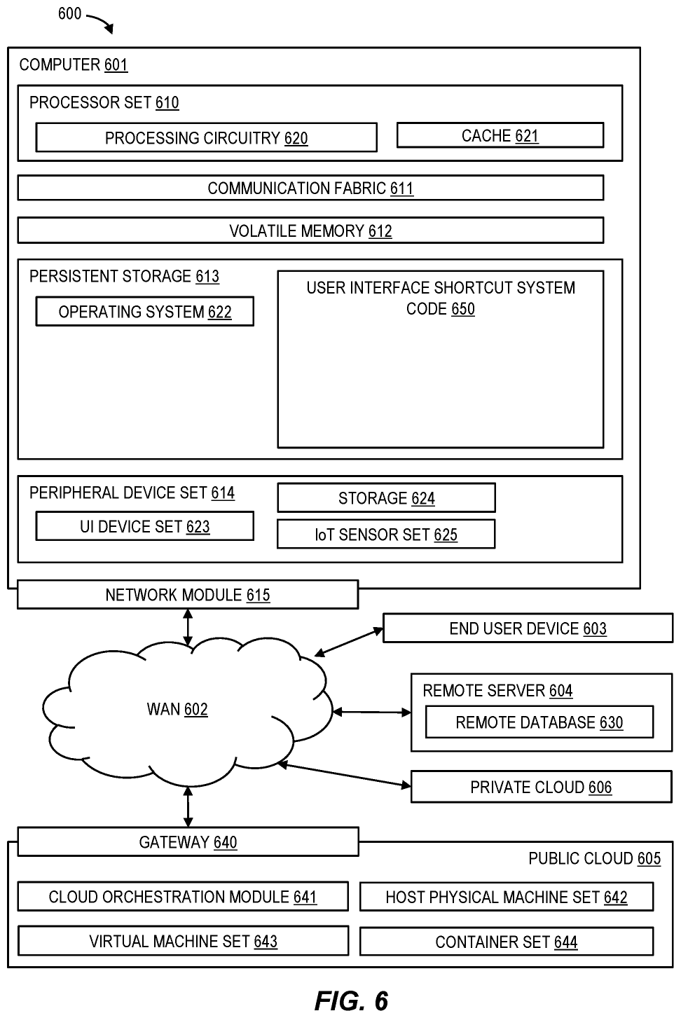

Referring to FIG. 6, computing environment 600 contains an example of an environment for the execution of at least some of the computer code involved in performing the inventive methods, such as user interface shortcut system code 650. In addition to block 650, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 650, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 650 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 650 typically includes at least some of the computer code involved in performing the inventive methods.

PERIPHERAL DEVICE SET 614 includes the set of peripheral devices of computer 601. Data communication connections between the peripheral devices and the other components of computer 601 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 615 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices. Computer readable program instructions for performing the inventive methods can typically be downloaded to computer 601 from an external computer or external storage device through a network adapter card or network interface included in network module 615.

WAN 602 is any wide area network (for example, the internet) capable of communicating computer data over non-local distances by any technology for communicating computer data, now known or to be developed in the future. In some embodiments, the WAN 602 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Improvements and modifications can be made to the foregoing without departing from the scope of the present invention.

The following paragraphs include some definitions for use in connection with this document.

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above-similar cautions apply to the term “embodiment.”
and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Set of thing(s): does not include the null set; “set of thing(s)” means that there exist at least one of the thing, and possibly more; for example, a set of computer(s) means at least one computer and possibly more.

What is claimed is:

1. A computer-implemented method for providing shortcuts for user interface interactive elements, said method comprising:
determining user interaction frequency with a plurality of interactive elements of a user interface display;
determining a most frequently used interactive element of the plurality of elements;
assigning a defined shortcut user input for the most frequently used interactive element by mapping a shortcut to the most frequently used interactive element in the display to interact with the most frequently used interactive element when the shortcut is entered; and
displaying the shortcut for the most frequently used interactive element.

2. The method of claim 1, wherein the determination of user interaction frequency with interactive elements of a user interface display includes:
generating a heatmap of user interactions with interactive elements of the plurality of interactive elements.

3. The method of claim 2, wherein of the determination of the most frequently used interactive element includes determining the most intensely used interactive element from the heatmap.

4. The method of claim 3, wherein the determination of user interaction frequency with interactive elements of a user interface display includes analyzing multiple users' interactions in the display using web application analytics.

5. The method of claim 4, wherein analyzing user interaction frequency with interactive elements of a user interface display includes analyzing a single user's interactions in the display using user specific analytics.

6. The method of claim 5 further comprising:
gathering user interactions with interactive elements of the display including input device inputs and navigation of the display.

7. A computer program product (CPP) for providing shortcuts for user interface interactive elements, the CPP comprising:
a storage device including at least one storage medium;
computer code collectively stored on the at least one storage medium of the storage device, with the computer code including data and instructions for causing a processor(s) set to perform the following operations:
determining user interaction frequency with a plurality of interactive elements of a user interface display;
determining a most frequently used interactive element of the plurality of elements;
assigning a defined shortcut user input for the most frequently used interactive element by mapping a shortcut to the most frequently used interactive element in the display to interact with the most frequently used interactive element when the shortcut is entered; and
displaying the shortcut for the most frequently used interactive element.

8. The CPP of claim 7, wherein the determination of user interaction frequency with interactive elements of a user interface display includes:
generating a heatmap of user interactions with interactive elements of the plurality of interactive elements.

9. The CPP of claim 8, wherein of the determination of the most frequently used interactive element includes determining the most intensely used interactive element from the heatmap.

10. The CPP of claim 9, wherein the determination of user interaction frequency with interactive elements of a user interface display includes analyzing multiple users' interactions in the display using web application analytics.

11. The CPP of claim 10, wherein analyzing user interaction frequency with interactive elements of a user interface display includes analyzing a single user's interactions in the display using user specific analytics.

12. The CPP of claim 11 further comprising:
gathering user interactions with interactive elements of the display including input device inputs and navigation of the display.

13. A computer system (CS) for providing shortcuts for user interface interactive elements, the CS comprising:
a processor(s) set;
a storage device including at least one storage medium;
computer code collectively stored on the at least one storage medium of the storage device, with the computer code including data and instructions for causing the processor(s) set to perform the following operations:
determining user interaction frequency with a plurality of interactive elements of a user interface display;
determining a most frequently used interactive element of the plurality of elements;
assigning a defined shortcut user input for the most frequently used interactive element by mapping a shortcut to the most frequently used interactive element in the display to interact with the most frequently used interactive element when the shortcut is entered; and
displaying the shortcut for the most frequently used interactive element.

14. The CS of claim 13, wherein the determination of user interaction frequency with interactive elements of a user interface display includes:
generating a heatmap of user interactions with interactive elements of the plurality of interactive elements.

15. The CS of claim 14, wherein of the determination of the most frequently used interactive element includes determining the most intensely used interactive element from the heatmap.

16. The CS of claim 15, wherein the determination of user interaction frequency with interactive elements of a user interface display includes analyzing multiple users' interactions in the display using web application analytics.

17. The CS of claim 16, wherein analyzing user interaction frequency with interactive elements of a user interface display includes analyzing a single user's interactions in the display using user specific analytics.

18. The CS of claim 17 further comprising:
gathering user interactions with interactive elements of the display including input device inputs and navigation of the display.
